(19) United States
(12) Patent Application Publication
(10) Pub. No.: US 2025/0181378 A1
(43) Pub. Date: Jun. 5, 2025

(54) FLASH STORAGE DEVICE PASSTHROUGH IN A VIRTUALIZATION SYSTEM

(71) Applicant: Micron Technology, Inc., Boise, ID (US)

(72) Inventors: Hui WANG, Shanghai (CN); Steffen BUCH, Taufkirchen (DE)

(21) Appl. No.: 18/932,099

(22) Filed: Oct. 30, 2024

Related U.S. Application Data
(60) Provisional application No. 63/604,435, filed on Nov. 30, 2023.

(51) Int. Cl. G06F 9/455; G06F 13/16

(52) U.S. Cl. CPC G06F 9/45558; G06F 13/1668; G06F 2009/45583

(57) ABSTRACT

In some implementations, a memory system may configure an association of queue resources to identifiers of respective virtual machines of one or more virtual machines, wherein the queue resources are associated with multiple queues of a universal flash storage (UFS) host. The memory system may receive a request indicating an identifier and one or more queue resources. The memory system may perform an action, via a UFS device, associated with the request based on the identifier, the one or more queue resources, and the association.

### CROSS REFERENCE TO RELATED APPLICATION

This patent application claims priority to U.S. Provisional Patent Application No. 63/604,435, filed on Nov. 30, 2023, and entitled “FLASH STORAGE DEVICE PASSTHROUGH IN A VIRTUALIZATION SYSTEM,” The disclosure of the prior Application is considered part of and is incorporated by reference into this Patent Application.

### TECHNICAL FIELD

The present disclosure generally relates to memory devices, memory device operations, and, for example, to flash storage device passthrough in a virtualization system.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples. A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

### BRIEF DESCRIPTION OF THE DRAWINGS

FIG. 1 is a diagram illustrating an example system capable of flash storage device passthrough in a virtualization system.

FIG. 2 is a diagram of an example of a universal flash storage (UFS) system.

FIG. 3 is a diagram of an example of device passthrough in a virtualization system.

FIG. 4 is a diagram of an example of flash storage device passthrough in a virtualization system.

FIG. 5 is a diagram of an example of multiple UFS command queues for a UFS host.

FIG. 6 is a diagram of an example of a command packet format for a UFS device.

FIG. 7 is a diagram of an example of flash storage device passthrough in a virtualization system.

FIG. 8 is a flowchart of an example method associated with flash storage device passthrough in a virtualization system.

### DETAILED DESCRIPTION

Input/output (I/O) virtualization is a technology that enables I/O resources in a system to be abstracted and/or virtualized. I/O virtualization may enable efficient and secure sharing and managing of I/O resources, such as network interfaces, storage devices, and/or other peripheral devices, across multiple virtual machines (VMs) or workloads in a way that is transparent to the software running within these VMs. I/O virtualization for memory storage may include technologies such as virtual storage controllers and virtual storage area networks (SANs). The I/O virtualization may allow multiple VMs to access shared storage resources, such as storage arrays or file systems, while abstracting the underlying physical storage. I/O virtualization may simplify management, lower costs, and/or improve performance of a system.

In some examples, a memory device, such as a universal flash storage (UFS) device, a managed NAND (mNAND) device, or another type of memory device, may be accessed via a virtualization system (e.g., by one or more VMs). A VM may access the memory device indirectly via a virtual disk. A virtual disk is a logical representation of disk storage resources that abstracts the complexities of physical storage and provides an efficient and manageable way to allocate, share, and/or manage storage for VMs in a virtualization system. The virtual disk may be abstracted and presented to the VMs as if the virtual disk were a physical disk. However, the use of the virtual disk introduces processing overhead and latency for requests (e.g., I/O requests) from a VM.

For example, a virtual disk frontend driver may be presented to a VM. The VM may use the virtual disk frontend driver (e.g., via a VM driver) to access the memory device. The virtual disk may perform a context switch from the VM to a hypervisor (e.g., may transition execution context and control from a running VM to the hypervisor to enable the hypervisor to regain control over the physical hardware and perform tasks, such as accessing the memory device). After performing the context switch, a virtual disk backend driver may communicate (e.g., via the hypervisor) with the memory device via a physical driver (e.g., a UFS physical driver) to perform the task requested by the VM. As a result, performing the task requested by the VM consumes processing resources associated with performing processing via the virtual disk driver(s) and/or performing the context switch. Additionally, this introduces latency associated with performing the task requested by the VM. For example, the processing associated with the accessing the memory device (e.g., via the virtual disk) may take more time than a processing time by the memory device to perform the requested task.

In some examples, a VM may use device passthrough (sometimes referred to as device assignment) to directly access and control a physical device, such as the memory device. For example, device passthrough enables a given physical device to be dedicated to a VM as if the VM were running natively on the hardware. Device passthrough can be used to grant a VM direct access to a memory device or a controller of the memory device. For example, the VM may access queue resources, such as registers for command processing or direct memory access (DMA) transfer, and/or interrupt resources, to perform one or more operations via an I/O queue of the memory device. In some implementations, a command queue system manages data transfers between a host (e.g., a VM) and the memory device. However, some memory devices (e.g., a UFS 3.1 device or another flash storage device) may support only a single queue or a limited number of queues. As a result, if the queue is dedicated to a given VM, other VMs may be unable to access the memory device. In other words, device passthrough may enable a VM to directly access the memory device (e.g., bypassing the hypervisor of the virtualization system), but may restrict access to the memory device for other VMs of the virtualization system.

Some implementations described herein enable flash storage device passthrough in a virtualization system. In some implementations, a memory device (e.g., a UFS device or another flash storage device) may allocate queues and/or queue resources (e.g., register resources or interrupt resources) to respective VMs in the virtualization system. For example, a hypervisor and each VM may be associated with one or more queue resources of the memory device (e.g., of a UFS host). The memory device may support multiple queues (e.g., multiple submission queues or I/O queues) and may associated with queues with different VMs. For example, the memory device may receive a command from a hypervisor to associate (e.g., to bind) one or more logical unit numbers (LUNs) with a given identifier (ID) of a VM. The memory device may receive a request (e.g., from a VM via device passthrough, such as via a UFS host) indicating an identifier of the VM and a LUN to be accessed. The memory device (e.g., a UFS device) may determine whether the identifier is associated with (e.g., mapped to) the LUN. The memory device may perform a task requested by the VM if the identifier is associated with the LUN. Alternatively, the memory device may refrain from performing the task (e.g., may return an error response or a fake success response to the UFS host) if the identifier is not associated with the LUN.

In some implementations, queue resources (of multiple queues of a UFS host) may be allocated to respective VMs such that there is isolation among the queues used by different VMs in the virtualization system. For example, the UFS host and/or the hypervisor may refrain from allocating the same queue or queue resources to multiple VMs. In some implementations, memory device management functionality may be reserved for the hypervisor. For example, if a request that includes an ID associated with a VM indicates a management task (such as a link up command, a hibernate command, a start stop unit (SSU) command, or another management command), then the memory device may refrain from performing the task (e.g., may return an error response or a fake success response).

As a result, the virtualization system may conserve processing resources and/or may reduce latency associated with performing tasks for the memory device via one or more VMs. For example, by enabling device passthrough for multiple VMs, processing resources and/or latency that would have otherwise been associated with the VMs accessing the memory device indirectly (such as via a virtual disk) may be reduced. By allocating queues (or queue resources), of multiple queues of the memory device, to respective VMs in the virtualization system, multiple VMs are enabled to access the memory device parallelly (e.g., at least partially at the same time). For example, each VM may host a physical driver of the memory device (e.g., where the physical driver is configured with the queue resources allocated for that VM), thereby enabling each VM to directly access and/or control the memory device. As used herein, “physical driver” may refer to a driver (e.g., a component) that enables communication between a VM and a physical device, such as a memory device. Further, by ensuring isolation among the queues used by different VMs in the virtualization system, a likelihood of two or more VMs attempting to access the same storage resources (e.g., the same LUNs) at the same time is reduced or eliminated. Additionally, by reserving control of management functions of the memory device to the hypervisor, a likelihood of one VM causing the memory device to perform a device management function (such as a hibernate function or an SSU function) that may negatively impact the performance of another VM is reduced or eliminated.

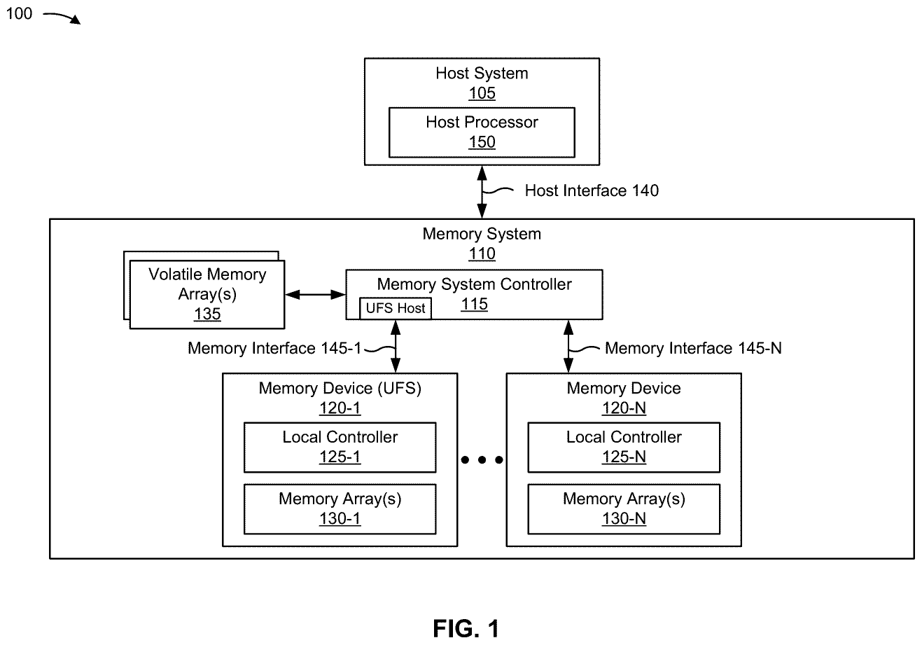

FIG. 1 is a diagram illustrating an example system 100 capable of flash storage device passthrough in a virtualization system. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120. In some implementations, the memory system controller 115 may include a UFS host, as described in more detail elsewhere herein.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120. In some implementations, a memory device 120 may be a UFS device, as described in more detail elsewhere herein.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, a memory array 130 may include a flash memory array, such as a UFS memory array (e.g., in such examples, the memory device 120 may be referred to as a UFS device). UFS is a specification or standard (e.g., defined, or otherwise fixed, by a standards organization, such as the joint electron device engineering council (JEDEC) solid state technology association). For example, UFS may be a type of flash memory that is commonly used in smartphones, vehicles, tablets, cameras, and/or other portable electronic devices. UFS memory is designed to offer faster data transfer speeds, lower power consumption, and/or improved reliability compared to other types of memory. UFS uses a layered architecture, consisting of a UFS host/device application layer (e.g., a UFS command set layer (UCS)), a transport layer (e.g., a UFS transport layer (UTP)), and a physical layer (e.g., a UFS interconnect layer (UIC)). A host interface layer is an interface (e.g., a host interface 140, described elsewhere herein) between the host system 105 and the memory system 110 that supports UFS storage. In some implementations, the host system 105 may include a UFS host configured to handle data transfer from an application processor of the host system 105 to the memory system 110. In some implementations, the memory system 110 (e.g., a controller of the memory system 110) may support and/or manage a UFS command queue. The UFS command queue may enable multiple read and write commands to be issued and processed in parallel, improving data access speed and overall storage performance for UFS. The UFS command queue may enable concurrent execution of multiple read and write commands. The memory system 110 and/or a memory device 120 may process several commands simultaneously, reducing latency and improving the overall throughput of data access operation for UFS. The UFS command queue may be managed by the memory system controller 115 or a local controller 125.

In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may a bus, such as an interconnect bus or a communication bus. In some examples, the host interface 140 may be a component of a system on chip (SoC) system of the memory system 110.

The memory interface 145 enables communication between the memory system 110 and the memory device 120 (e.g., between the memory system controller 115 and the memory device 120). The memory interface 145 may include a non-volatile memory interface (e.g., for communicating with non-volatile memory), for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, and/or an eMMC interface, among other examples. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, and/or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to configure, for a UFS device of the system, an association of UFS resources to identifiers of respective virtual machines of one or more virtual machines; provide, via a hypervisor and for each virtual machine of the one or more virtual machines, one or more queue resources, of queue resources of a UFS host of the system, that are associated with that virtual machine based on the association, wherein each virtual machine is associated with one or more queues of multiple queues of the UFS host; receive, from a virtual machine of the one or more virtual machines and via the UFS host, a request to perform an operation associated with the memory, wherein the request indicates an identifier and is received via a queue of the multiple queues; and perform, by the UFS device, an action associated with the request based on the identifier, a UFS resource associated with the request, and the association.

In some implementations, one or more systems, devices, apparatuses, components, and/or controllers of FIG. 1 may be configured to configure, by a UFS device, an association of LUNs to identifiers of respective virtual machines of one or more virtual machines; receive, from a UFS host, a request indicating an identifier and a LUN, wherein the request is associated with a queue of multiple queues associated with the UFS host; and perform, via the UFS device, an action associated with the request based on the identifier, the LUN, and the association.

In some implementations, one or more systems, devices, apparatuses, components, and/or controllers of FIG. 1 may be configured to receive, via a hypervisor, an indication of host one or more queues resources of multiple queues of a UFS host; host, via a virtual machine, a physical driver of the UFS host and the queues resources; and transmit, to the UFS host and using at least one of the queue resources, a request to access memory associated with a UFS device.

In some implementations, one or more systems, devices, apparatuses, components, and/or controllers of FIG. 1 may be configured to receive a command indicating a set of LUNs to be associated with one or more identifiers, wherein the set of LUNs and the one or more identifiers have non-overlapping associations; configure, for a UFS host, an association of the set of LUNs to identifiers of respective virtual machines of one or more virtual machines; configure, via a hypervisor and for each virtual machine of the one or more virtual machines, one or more queue resources for respective queues of the UFS host that are associated with that virtual machine; receive a request to perform an operation associated with one or more LUNs of the set of LUNs, wherein the request indicates an identifier; and perform an action associated with the request based on whether the association indicates that the identifier is associated with the one or more LUNs.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

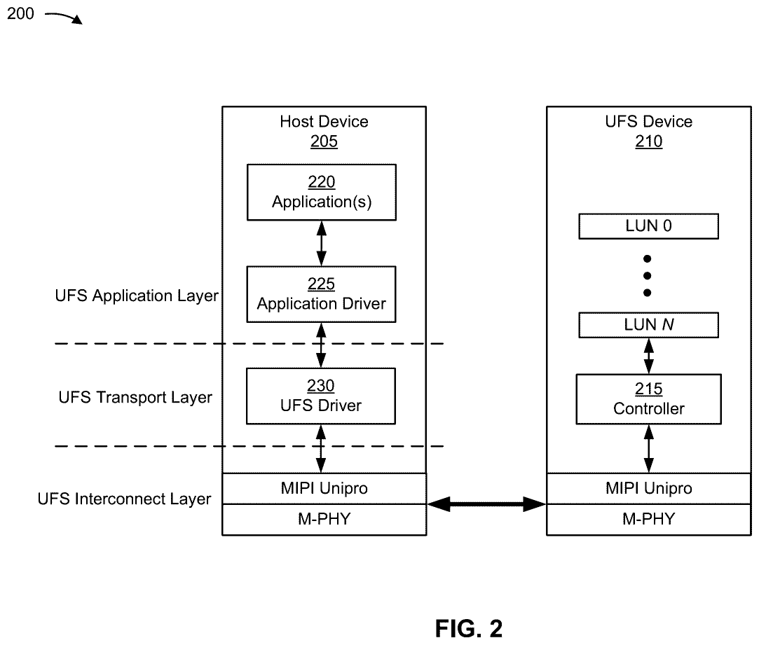

FIG. 2 is a diagram of an example of a UFS system 200. The UFS system 200 may include a host device 205 (e.g., the host system 105) and a UFS device 210 (e.g., the memory system 110 or a memory device 120). The UFS device 210 may include a non-volatile memory array (e.g., a flash memory array, such as a memory array 130) and a controller 215 (e.g., the memory system controller 115 or a local controller 125). The controller 215 may be a flash memory controller or a UFS controller.

As shown in FIG. 2, UFS may include a UFS application layer. The UFS application layer may be a layer in a UFS protocol stack associated with an interface between a file system of the host device 205 and the UFS device 210, allowing an operating system and one or more applications 220 of the host device 205 to interact with the UFS device 210. The UFS application layer (e.g., via an application driver 225, such as a SCSI driver) may abstract the complexities of flash memory management, wear-leveling, and/or error correction, reducing the complexity associated with applications to work with UFS storage.

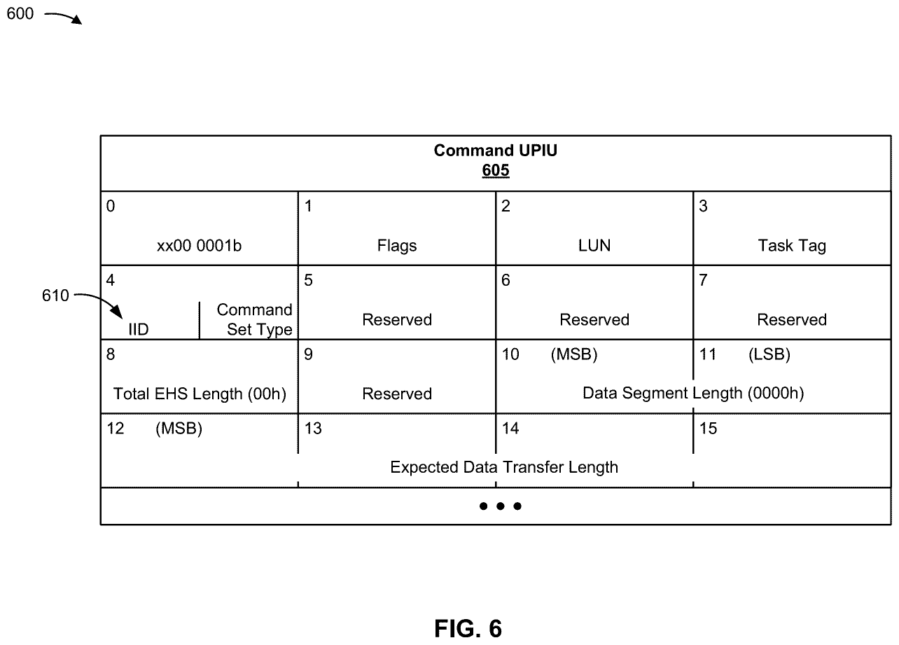

The UFS protocol stack may include a UFS transport layer (UTP). The UFS transport layer may be associated with managing physical and data link aspects of communication between the host device 205 and the UFS device 210 (e.g., via a UFS driver 230). The UFS transport layer may abstract the physical and low-level communication complexities, allowing the upper layers of the UFS protocol stack, such as the UFS application layer, to interact with the UFS device 210. The UFS transport layer may be associated with performing operation(s) for physical layer management and data link layer management (e.g., UFS interconnect layer management), initialization and link configuration, and/or command queuing and transport layer protocols, among other examples. Transactions for the UFS transport layer may include packets referred to as UFS protocol information units (UPIUs). There may be different types of UPIUs for handling application commands, data operations, task management operations, and/or query operations, among other examples. Each transaction may include a command UPIU, zero or more data in or data out UPIUs, and a response UPIU. A command UPIU is depicted and described in more detail in connection with FIG. 6.

The UFS protocol stack may include a UFS interconnect layer. The UFS interconnect layer may be the lowest layer of the UFS protocol stack. The UFS interconnect layer may handle the connection between the host device 205 and the UFS device 210. As shown in FIG. 2, the UFS interconnect layer may include a universal protocol (UniPro) component that is configured to perform UniPro operations defined, or otherwise fixed, by the mobile industry processor interface (MIPI) alliance. The UniPro component may have four layers. Layer 1 may be a physical layer, layer 2 may be a data link layer, layer 3 may be a network layer, and layer 4 may be a transport layer. Layer 1 and layer 2 may ensure the data integrity and reliability of the communication link between the host device 205 and the UFS device 210. Layer 3 and layer 4 may ensure that the data is routed to the intended UFS host or device. The UFS interconnect layer may include an M-PHY component (e.g., that uses a physical layer protocol defined, or otherwise fixed, by the MIPI Alliance). UFS may use the M-PHY component for physical layer operations and the UniPro component for data link layer operations.

As shown in FIG. 2, the UFS device 210 may include one or more logical units (LUs). Each LU may have an identifier within a UFS referred to as a LU number (LUN), shown as LUN 0 through LUN N. An LU may be an independently (e.g., uniquely) addressable memory unit within the UFS device 210 via logic block address (LBA). An LU may be a fixed-size unit of data that can be read from or written to within the UFS device 210. LUs in UFS provide a level of abstraction that allows the host device 205 to perform operations with the UFS device 210 without needing to understand the details of NAND flash memory management. The UFS device 210 may expose one or more LUNs and respective logical address space, making it easier for a file system and application(s) 220 of the host device 205 to interact with the flash memory as if the UFS device 210 were a traditional block-based device.

As indicated above, FIG. 2 is provided as an example. Other examples may differ from what is described with regard to FIG. 2.

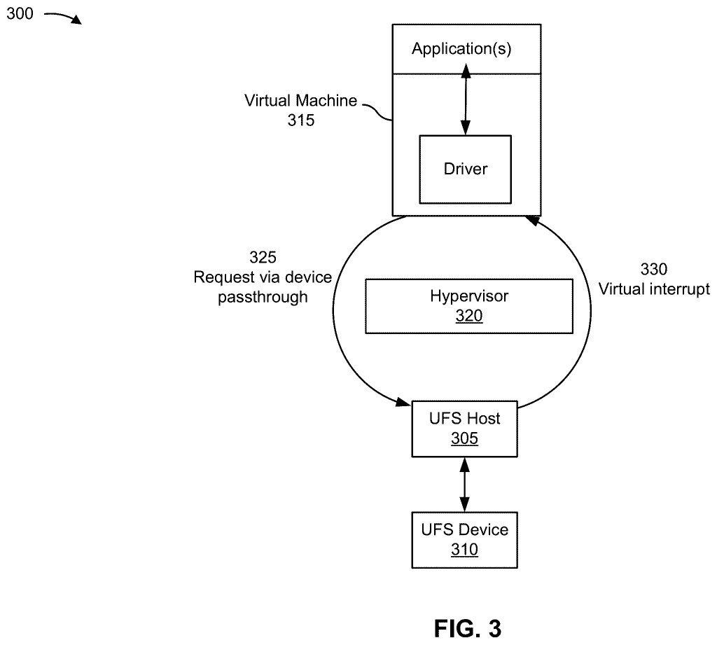

FIG. 3 is a diagram of an example 300 of device passthrough in a virtualization system. As shown in FIG. 3, the virtualization system may include a UFS host 305 (e.g., included in the memory system controller 115 or an SoC component of a memory system), a UFS device 310 (e.g., a memory device 120 configured to use UFS), a virtual machine 315, and a hypervisor 320.

The hypervisor 320 may enable the simultaneous operation of multiple virtual machines (such as the virtual machine 315) on a single physical device. The hypervisor 320 serves as an intermediary between physical hardware (e.g., the UFS host 305 or the UFS device 310) and the virtualized operating systems (e.g., the virtual machine 315). The hypervisor 320 may manage and allocate hardware resources, such as processing units, memory, storage, and/or network interfaces, among other examples, to each VM. The hypervisor 320 may create a virtualized environment that isolates and runs multiple VMs, allowing the VMs to share the underlying hardware while maintaining security and resource allocation boundaries.

The virtual machine 315 may be an emulation of a physical device (such as an emulation of a host system 110 or a CPU). The virtual machine 315 operates as an isolated and self-contained computing environment within a host system, mimicking the behavior of a physical device. The virtual machine 315 may be created and managed by the hypervisor 320. Each virtual machine may execute an operating system and separate software applications (e.g., as shown in FIG. 3), similar to a physical device.

This separation of virtual machines allows multiple operating systems and workloads to coexist on a single physical device, sharing resources while maintaining isolation and security boundaries. For example, multiple virtual machines may share access to the memory resources of the UFS device 310.

Device passthrough, in the context of virtualization, refers to a feature that allows the virtual machine 315 to have direct and exclusive access to a physical hardware device. With device passthrough, the hypervisor 320 enables the virtual machine 315 to bypass a typical emulation of hardware and instead communicate directly with a specific physical device, such as the UFS host 305. Device passthrough may also be referred to as hardware passthrough or direct device assignment, among other examples. Device passthrough enhances the performance of virtualized workloads and reduces latency by eliminating the overhead associated with emulating hardware. For example, as shown in FIG. 3, the virtual machine 315 may host a physical driver (e.g., a UFS driver or a UFS transport layer driver) associated with the UFS host 305.

For example, as shown by reference number 325, the virtual machine 315 (e.g., via the physical driver hosted by the virtual machine 315) may transmit a request directly to the UFS host 305 via device passthrough. As shown in FIG. 3, the request may bypass the hypervisor 320. This reduces latency and conserves processing resources that would have otherwise been associated with the hypervisor 320 emulating the physical device, such as in a virtual disk solution where a backend driver of the UFS host 305 is hosted by the hypervisor 320. Additionally, as shown by reference number 330, the UFS device 310 may transmit a virtual interrupt communication directly to the virtual machine 315 (e.g., bypassing the hypervisor 320). As used herein, an “interrupt” may refer to a hardware or software mechanism used to signal a device that a particular event or condition has occurred. An interrupt may include an I/O interrupt (e.g., signaling a device to handle the completion of I/O operations, which may include reading or writing data to/from a memory array), an error handling interrupt (e.g., to notify an operating system of an error), a disk activity and scheduling interrupt (e.g., to facilitate the scheduling of disk I/O requests), and/or a caching interrupt, among other examples. As shown in FIG. 3, because the virtual machine 315 hosts the physical driver, the virtual machine 315 and the UFS host 305 may directly communicate with each other, thereby reducing latency and conserving processing resources associated with the communications.

To enable the device passthrough described herein, the physical driver in the virtual machine 315 may support one or more capabilities. The one or more capabilities may include a capability to access host hardware memory (e.g., DRAM or system on chip (SoC) host registers), a capability to manage DMA transfer from/to the UFS device 310, and/or a capability to handle interrupts from an SoC host, among other examples. For example, to enable the device passthrough described herein, the virtualization system (e.g., the virtual machine 315) may need a two-stage memory management unit (MMU) to access DRAM or SoC host registers). For example, the two-stage MMU may be a hardware capability designed for non-volatile memory access (e.g., DRAM or SoC host registers).

For example, in typical virtualization systems, the hypervisor 320 may control the memory that the virtual machine 315 can access. For example, an operating system of the virtual machine 315 may use an intermediate physical address (e.g., that the operating system considers to be the actual physical address for DRAM or SoC host registers). Typically, the operating system configures a stage one translation table and the hypervisor 320 configures a stage two translation table. Each memory access from an application running in the virtual machine 315 may undergo two stages of translation in the MMU (e.g., referred to herein as a two-stage MMU). The MMU will first use the stage one table(s) to convert a virtual address to an intermediate physical address, then the MMU may use the stage two table(s) to convert the intermediate physical address to a real physical address for DRAM or SoC host registers. The two-stage conversion may be done automatically by MMU hardware.

Additionally, to bypass the hypervisor 320, the virtualization system may support DMA remapping. For example, typically the hypervisor 320 may configure an I/O MMU (IOMMU) table for converting between a guest physical address (GPA) (e.g., used by the virtual machine 315) and a host physical address (HPA). If the virtual machine 315 hosts the physical driver of the UFS device 310, then the virtual machine 315 may manage DMA operations, such as read or write operations. The virtual machine 315 may provide one or more GPAs to a register of a UFS host on the UFS device 310. A system MMU (SMMU) of the virtualization system may translate the one or more GPAs to one or more HPAs to access a memory array (e.g., a DRAM array) directly. For example, DMA remapping may be a host side feature provided via an SMMU module or an SMMU component. DMA remapping may be transparent to the virtual machine 315.

Additionally, to bypass the hypervisor 320, the virtualization system may support interrupt remapping. For example, typically, interrupt communications are provided to the hypervisor 320, which then forwards the interrupt communications to the appropriate virtual machine(s). To enable the physical driver to be hosted on the virtual machine 315, the virtualization system may remap interrupt communications to the virtual machine 315. The interrupt remapping may include the UFS device 310 providing an interrupt communication to the hypervisor 320. The hypervisor 320 may determine that the interrupt communication is from a UFS host of the UFS device 310 and intended for the virtual machine 315. The hypervisor 320 may generate a virtual interrupt and provide the virtual interrupt to the virtual machine 315. In some examples, the interrupt remapping may be performed automatically via an interrupt routing table on the hypervisor 320 (e.g., rather than first transmitting the interrupt to the hypervisor 320). For example, interrupt remapping may be a host side feature provided by a generic interrupt controller (GIC) hardware module. Interrupt remapping may be configured by the hypervisor 320 prior to launching the virtual machine 315. Interrupt remapping may be transparent to the virtual machine 315 (e.g., after bypassing the hypervisor 320, interrupt remapping may be automatically performed via the GIC hardware module).

However, as described elsewhere herein, if the physical driver is hosted by a given virtual machine, other virtual machines may be unable to access the UFS host 305 (or the UFS device 310 via the UFS host 305). For example, in some cases, the UFS host 305 may support only a single command queue. As a result, if the queue is dedicated to a given virtual machine (e.g., the virtual machine 315 where the physical driver is hosted), other virtual machines may be unable to access the UFS host 305. In other words, device passthrough may enable the virtual machine 315 to directly access the UFS host 305 (e.g., bypassing the hypervisor 320), but may restrict access to the UFS host 305 for other virtual machines of the virtualization system.

As indicated above, FIG. 3 is provided as an example. Other examples may differ from what is described with regard to FIG. 3.

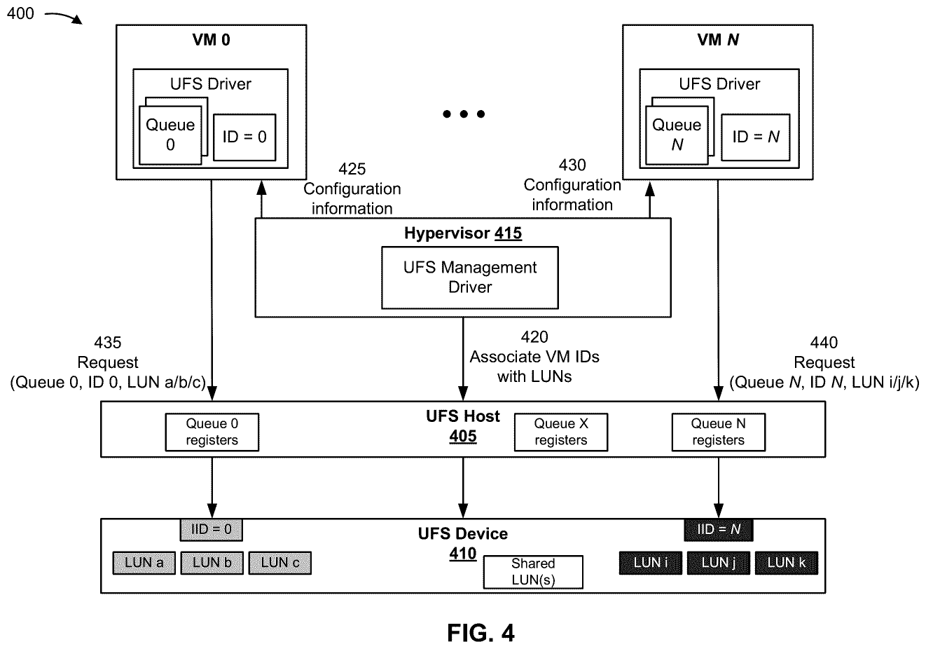

FIG. 4 is a diagram of an example 400 of flash storage device passthrough in a virtualization system. The operations described in connection with FIG. 4 may be performed by the memory system 110 and/or one or more components of the memory system 110, such as the memory system controller 115, one or more memory devices 120, and/or one or more local controllers 125. As shown in FIG. 4, the example 400 includes a UFS host 405 (e.g., a component of the memory system controller 115 or an SoC component), a UFS device 410 (e.g., a memory device 120), a hypervisor 415, and one or more virtual machines (shown as VM 0 to VM N). The hypervisor 415 and the one or more virtual machines may be included in a CPU or host device.

As shown in FIG. 4, the hypervisor 415 may host a UFS management driver to enable the hypervisor 415 to cause one or more management functions for the UFS host 405 and/or the UFS device 410 to be performed through the UFS host 405.

Additionally, each virtual machine may host a UFS driver (e.g., a physical driver, such as a driver for a UFS transport layer) to enable direct communication between each virtual machine and the UFS device 410 (e.g., via the UFS host 405), as described in more detail elsewhere herein.

The hypervisor 415 may configure one or more operations described herein. For example, as shown by reference number 420, the hypervisor 415 may transmit, and the UFS device 410 may receive (via the UFS host 405), an indication (e.g., a request or a command) to associate virtual machine IDs with one or more LUNs of the UFS device 410. For example, the UFS device 410 may receive, via the hypervisor 415 (and via the UFS host 405), an indication to bind different LUNs to one or more identifiers of virtual machines. In some implementations, the UFS device 410 may receive a command indicating a set of LUNs to be associated with one or more identifiers. For example, the hypervisor 415 may transmit a command (e.g., a vendor command) to bind IDs (or virtual machines) with specific LUNs (e.g., to the UFS host 405). The IDs of the virtual machines may be initiator identifiers (IIDs) included in a UPIU header, as depicted and described in more detail in connection with FIG. 6.

The UFS device 410 may configure, based on the command received from the hypervisor 415 through the UFS host 405, an association between the different LUNs and respective identifiers of the virtual machines. In some implementations, the hypervisor 415 may configure an association of queue resources of the UFS host 405 (of multiple queues of the UFS host 405) to identifiers of respective virtual machines of one or more virtual machines. The queue resources may be associated with multiple queues of the UFS host 405. For example, the UFS host 405 may have multiple UFS command queues (e.g., where each queue includes a submission queue and a completion queue). Each UFS command queue may have one or more dedicated register resources of UTP request transfers. Additionally, each UFS command queue may have a dedication interrupt identifier. The queue resources for a given queue may include the one or more register resources (e.g., one or more queue registers of the UFS host 405) and one or more interrupt identifiers for the given queue.

Each register resource may be associated with one or more addresses, such as one or more addresses (e.g., GPA values) to be dedicated or allocated to a given virtual machine. For example, a register resource may be associated with one or more HPAs that are mapped to the one or more GPA values. As described elsewhere herein, a virtualization system may support a two-stage MMU component and may be configured to translate a GPA (e.g., indicated in a command from a virtual machine) into an HPA for a physical address in the UFS host 405.

In some implementations, the hypervisor 415 and/or the UFS host 405 may configure the association of the queue resources such that no two IDs are associated with (e.g., are bound to) the same dedicated queue resource of the UFS host 405. A dedicated queue resource may be a queue resource that is allocated or configured for a given virtual machine. For example, the hypervisor 415 and/or the UFS device 410 may configure the association of the queue resources (e.g., the association of virtual machine IDs to LUNs) with non-overlapping associations such that no two IDs are associated with the same dedicated queue resources. In other words, the hypervisor 415 and each virtual machine may be configured with one or more UFS command queue resource, but an overlap in the UFS command queue resources between two or more entities may not be allowed.

For example, the hypervisor 415 and/or the UFS host 405 may configure a first one or more UFS command queue resources to be associated with a first ID of a first virtual machine (e.g., the VM 0). For example, the hypervisor 415 and/or the UFS host 405 may configure one or more UFS queues (e.g., of the UFS host 405) and/or one or more LUNs (e.g., of the UFS device 410) to be associated with the ID of the VM 0. The hypervisor 415 and/or the UFS host 405 may configure a second one or more UFS queue resources to be associated with a second ID of a second virtual machine (e.g., the VM N). For example, the hypervisor 415 and/or the UFS host 405 may configure one or more UFS queues (e.g., of the UFS host 405) and/or one or more LUNs (e.g., of the UFS device 410) to be associated with the ID of the VM N. The first one or more queue resources and the second one or more queue resources may be mutually exclusive. In other words, there may be no overlap between the UFS queue resources and/or the LUNs that are configured or allocated for each virtual machine. This may ensure that no two virtual machines may attempt to perform an operation on the same registers at the same time. For example, if two or more virtual machines were to attempt to write to the same DMA register(s) at the same time, the memory system may experience a failure. By ensuring that there is no overlap in the UFS command queue resources and/or LUNs configured or allocated to each virtual machine, a likelihood of two or more virtual machines attempting to access the same memory resources of the UFS host 405 at the same time may be reduced or eliminated.

In some implementations, there may be one or more resources (e.g., LUNs) that are shared among two or more (or all) virtual machines (and/or the hypervisor 415). For example, as shown in FIG. 4, the UFS device 410 may include one or more shared LUNs that can be accessed by each virtual machine. For example, there may be one or more shared LUNs between IDs/VMs with a read/write flag. For example, the one or more shared LUNs may be memory in which data that is shared among multiple virtual machines is stored. In some implementations, the hypervisor 415 and/or the UFS host 405 may configure multiple identifiers, of respective virtual machines, to be associated with the shared LUNs.

The hypervisor 415 may configure each virtual machine with UFS queue resources (e.g., of the UFS host 405) that are associated with or allocated to that virtual machine. For example, as shown by reference number 425, the hypervisor 415 may transmit, and a first virtual machine (e.g., the VM 0) may receive, configuration information. Similarly, as shown by reference number 430, the hypervisor 415 may transmit, and a second virtual machine (e.g., the VM N) may receive, configuration information. In other words, the hypervisor 415 may provide, to each virtual machine, configuration information for that virtual machine. The configuration information may include an indication of the one or more queue resources (e.g., one or more UFS queue resources) that are configured for that virtual machine.

For example, the hypervisor 415 may provide, via configuration information for hardware components of a system, an indication of the one or more queue resources for a given virtual machine. For example, the configuration information may be included in a device tree file. The configuration information may indicate one or more UFS queue register resources (e.g., one or more GPAs), one or more interrupt identifiers, and/or an ID of the virtual machine (e.g., an IID to be indicated in requests (e.g., UPIUs) transmitted by the virtual machine, among other examples). For example, as shown in FIG. 4, the VM 0 may be configured with resources of a queue 0 (e.g., a first UFS queue) of the UFS host 405. The VM N may be configured with resources of a queue N (e.g., a second UFS command queue) of the UFS host 405. Each virtual machine may be configured with queue resources for one or more UFS queues of the UFS host 405 (e.g., in some examples, a single virtual machine may be configured with resources for multiple UFS queues).

As shown in FIG. 4, each virtual machine may host a UFS driver and resources for one or more queues, of the multiple UFS command queues of the UFS host 405, that are associated with that virtual machine. The hypervisor 415 may cause UFS I/O drivers (e.g., physical drivers of the UFS host 405) to be hosted by respective virtual machines (e.g., via providing the configuration information to the respective virtual machines). For example, based on being configured with the one or more UFS queue resources, the virtual machine may be configured with one or more register resources (e.g., one or more GPAs) and/or one or more interrupt IDs that are allocated for that virtual machine. Because the UFS host 405 supports a multi-circular queue (MCQ) feature, multiple virtual machines may be configured to host a physical driver for the UFS host 405 (e.g., where each virtual machine is configured to access the UFS device 410 via separate UFS queues of the UFS host 405). For example, the hypervisor 415 and each virtual machine may hold one or more UFS queue resources (e.g., non-overlapping resources).

As shown in FIG. 4, the hypervisor 415 may host a UFS management driver that is configured to enable the hypervisor 415 to perform one or more management functions on the UFS device 410. For example, the hypervisor 415 may have an identifier. The UFS device 410 may be configured to identify the identifier of the hypervisor 415 and permit the hypervisor 415 to perform one or more management functions on the UFS device 410. The one or more virtual machines may only be permitted to perform I/O operations with the UFS device 410, such as read operations and/or write operations, among other examples.

For example, as shown by reference number 435, the VM 0 may transmit, and the UFS device may receive, a request. The VM 0 may transmit the request directly to the UFS host 405 (e.g., via device passthrough, in a similar manner as described elsewhere herein). The request may be included in a UPIU. The request may be an I/O command. The request may be provided via a queue (e.g., a UFS command queue) of the UFS host 405. For example, the VM 0 may transmit the request via a queue 0 based on being configured with queue resources for the queue 0 (e.g., as described in connection with reference number 425). The request may indicate an identifier of the VM 0. For example, the identifier may be included in a header of the UPIU, such as in an IID field of the UPIU header. For example, the UFS host 405 may receive a UTP command that includes the identifier of the VM 0 in an IID field of the UTP command. As an example, the ID of the VM 0 may be an ID 0. Additionally, the request(s) may indicate one or more LBAs in a given LUN to be accessed. For example, the request may indicate one or more LBAs in a given LUN to be accessed to perform the I/O request.

Similarly, as shown by reference number 440, the VM N may transmit, and the UFS host 405 may receive, a request. The VM N may transmit the request directly to the UFS host 405 (e.g., via device passthrough, in a similar manner as described elsewhere herein). The request may be included in a UPIU. The request may be an I/O command. The request may be provided via another queue (e.g., another UFS command queue) of the UFS host 405. For example, the VM N may transmit the request via a queue N based on being configured with queue resources for the queue N (e.g., as described in connection with reference number 430). The request may indicate an identifier of the VM N. For example, the identifier may be included in a header of the UPIU, such as in an IID field of the UPIU header. As an example, the ID of the VM N may be an ID N. Additionally, the request(s) may indicate one or more LBAs in a given LUN to be accessed. For example, the request may indicate one or more LBAs in a given LUN to be accessed to perform the I/O request.

The UFS device 410 may perform action(s) to process the request(s) based on the identifiers, the queues, and the association of IDs to LUNs, as described elsewhere herein. For example, the UFS device 410 may determine an ID associated with a UFS command (e.g., via the IID field in a UPIU). The UFS device 410 may determine whether the association indicates that the ID is associated with the UFS command queue via which the request is received. For example, if the association (e.g., configured as described in connection with reference number 420) indicates that the ID is associated with the UFS command queue, then the UFS device 410 may complete the request. Alternatively, if the association (e.g., configured as described in connection with reference number 420) indicates that the ID is not associated with the UFS command queue, then the UFS device 410 may deny or refrain from completing the request (e.g., and may return an error indication).

In some implementations, the UFS device 410 may perform the action to process a request based on a function that is requested to be performed. For example, a request may be associated with a management command for the UFS device 410, such as a UIC command, a hibernate command, a link up command, a query command (e.g., a query read command or a query write command), and/or an SSU command, among other examples. The UFS device 410 may determine whether the ID indicated by the request (e.g., via the IID field) indicates that the request is from a virtual machine or the hypervisor 415. For example, the UFS device 410 may determine that the ID indicates that the request is from a virtual machine. In such examples, the UFS device 410 may refrain from completing the request (e.g., to perform a management command) based on the request being from the virtual machine. For example, each virtual machine may remove UIC command functions (e.g., management command functions) from the UFS driver hosted by that virtual machine.

For a query read command from a virtual machine, the UFS device 410 may provide a response to the query read (e.g., may perform the requested task) and/or may provide virtual device information in response to the query read command. For a query write command, the UFS device 410 may ignore the command and/or may provide an indication of successfully completing the command without actually performing the requested task (e.g., may respond with a “fake” success). For SCSI commands from a virtual machine, the UFS device 410 may perform I/O SCSI requests. For other SCSI commands from a virtual machine, the UFS device 410 may provide an indication of successfully completing the command without actually performing the requested task (e.g., may respond with a “fake” success).

The hypervisor 415 may be associated with an ID that indicates that a request including the ID is from the hypervisor 415. For example, the hypervisor 415 may transmit a management command with that ID (e.g., an IID reserved for the hypervisor 415). The UFS device 410 may be configured to recognize that ID and handle or perform the management command(s) normally. For example, the UFS device 410 may determine that the identifier indicates that the request (e.g., to perform a management command) is from the hypervisor 415. The UFS device 410 may perform an action to complete the request based on the request being from the hypervisor 415.

As indicated above, FIG. 4 is provided as an example. Other examples may differ from what is described with regard to FIG. 4.

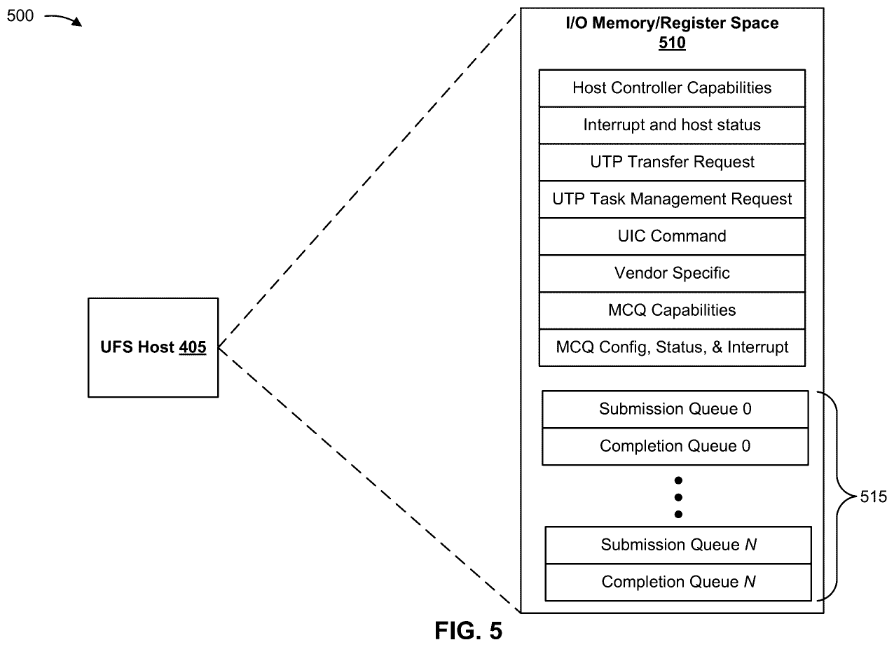

FIG. 5 is a diagram of an example 500 of multiple UFS command queues for a UFS host. As shown in FIG. 5, the UFS host 405 may include an I/O memory/register space 510. The I/O memory/register space 510 may indicate capability and/or configuration information for I/O capabilities of the UFS host 405. For example, the I/O memory/register space 510 may indicate information for one or more host controller capabilities, interrupt and host status, UTP transfer requests, UTP task management requests, UIC commands, and/or vendor specific information, among other examples.

Additionally, as shown in FIG. 5, the I/O memory/register space 510 may indicate one or more MCQ capabilities of the UFS host 405. For example, the UFS host 405 may support one or more MCQ capabilities. Additionally, the I/O memory/register space 510 may indicate MCQ configuration, status, and/or interrupt information for multiple UFS command queues of the UFS host 405. For example, data transfer between the UFS host 405 and the UFS device 410 (e.g., that is controller via a UFS driver in a virtual machine) may occur via an array of data structures referred to as UTP transfer request descriptors (UTRD). The UTRDs may be contained in a list referred to as a UTP transfer request list (UTRL) in host memory. A UTRD contains information required for a host controller (e.g., a controller of a virtual machine) to create a command UPIU to be sent to the UFS host 405 and also to pass the response from the UFS host 405 received over response UPIU. A UTRL may be associated with a doorbell register which indicates which UTRDs are available for processing. When the HCl driver writes (rings) to the doorbell register, the UFS host 405 is notified of a new work item added to the UTRL. When the UFS host 405 has received the response from the UFS device 410, the UFS host 405 generates an interrupt that allows the HCl driver to handle the completion.

For the UFS host 405 that supports MCQ functions, the UFS host 405 may have multiple queues 515 (e.g., rather than a single UTRL). Each queue supports an implementation-defined number of elements. Additionally, as shown in FIG. 5, separate queues are used to represent submitted and completed commands (e.g., via submission queues and completion queues, respectively). Each MCQ (e.g., each UFS command queue) may include a submission queue, a completion queue, and a doorbell register. A submission queue may be a circular queue of UTRDs, where the UFS driver of a virtual machine is the producer and the UFS host 405 is the consumer. The UFS driver may submit the commands to the UFS host 405 by adding UTRDs to the submission queue and incrementing the doorbell tail pointer associated with the submission queue. Each submission queue may be mapped to a completion queue. A completion queue may be implemented as a circular queue, where the host controller is the producer and the UFS driver of the virtual machine is the consumer. After receiving a response UPIU from the UFS device 410, the UFS host 405 may update the relevant head entry of the completion queue and raise the interrupt to the UFS driver.

As described elsewhere herein, resources for one or more MCQs may be bound to an ID of a given virtual machine. The UFS driver of the virtual machine may provide requests to the submission queue of the MCQs associated with that virtual machine. This may enable multiple virtual machines to access the UFS host 405 at the same time via device passthrough, thereby reducing processing resources and/or latency associated with request(s) from the VMs.

As indicated above, FIG. 5 is provided as an example. Other examples may differ from what is described with regard to FIG. 5.

FIG. 6 is a diagram of an example 600 of a command packet format for a UFS device. For example, FIG. 6 depicts an example format of a command UPIU 605. The command UPIU includes a field 610 for indicating an identifier (e.g., of a virtual machine or the hypervisor 415), as described in more detail elsewhere herein.

For example, as shown in FIG. 6, the field 610 may be an IID field. The field 610 may be included in a header of the command UPIU 605. When generating a command UPIU, a virtual machine may include the identifier configured for the virtual machine in the field 610. The UFS device 410 may receive the command UPIU (e.g., via the UFS host 405). The UFS device 410 may determine the identifier associated with the command UPIU based on information included in the field 610. For example, the UFS device 410 may be enabled to determine which virtual machine the command UPIU is associated with based on the information included in the field 610, thereby enabling the UFS device 410 to properly process a request indicated by the command UPIU, as described in more detail elsewhere herein.

As indicated above, FIG. 6 is provided as an example. Other examples may differ from what is described with regard to FIG. 6.

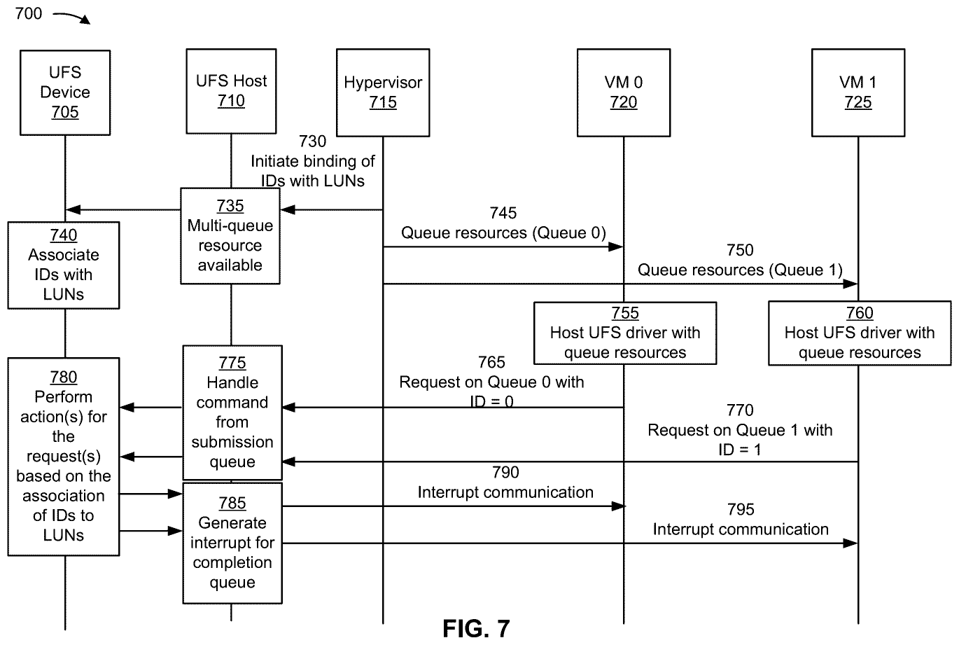

FIG. 7 is a diagram of an example 700 of flash storage device passthrough in a virtualization system. The operations described in connection with FIG. 7 may be performed by the memory system 110 and/or one or more components of the memory system 110, such as the memory system controller 115, one or more memory devices 120, and/or one or more local controllers 125. As shown in FIG. 7, the example 700 includes a UFS device 705 (e.g., which may be, or may be similar to, the UFS device 410), a UFS host 710 (e.g., which may be, or may be similar to, the UFS host 405), a hypervisor 715 (e.g., which may be, or may be similar to, the hypervisor 415), a VM 0 720, and a VM 1 725.

As shown by reference number 730, the hypervisor 715 may transmit, and the UFS device 705 may receive (e.g., via the UFS host 710), an indication to initiate binding of IDs with LUNs. For example, the hypervisor 715 may transmit, and the UFS device 705 may receive (e.g., via the UFS host 710), an indication (e.g., a request or a command) to associate virtual machine IDs with one or more LUNs of the UFS device 705. For example, the UFS device 705 may receive, via the hypervisor 715, an indication to bind different LUNs to one or more identifiers of virtual machines (such as an ID 0 of the VM 0 720 to a first one or more LUNs and an ID 1 of the VM 1 725 to a second one or more LUNs). In some implementations, the UFS device 705 may receive a command indicating a set of LUNs to be associated with one or more identifiers. For example, the hypervisor 715 may transmit a command (e.g., a vendor command) to bind IDs (or virtual machines) with specific LUNs. As described elsewhere herein, the IDs may be IIDs indicated via a header of a UPIU. For example, as shown by reference number 735, the UFS host 710 may make multi-queue resources available to the virtualization system and/or the UFS device 705. The UFS host 710 may support multiple queues (e.g., multiple UFS queues), as described in more detail elsewhere herein.

As shown by reference number 740, the UFS device 705 may associate IDs with LUNs (e.g., as indicated or requested by the hypervisor 715). The UFS device 705 may configure, based on receiving the indication to initiate binding from the hypervisor 715, an association between the different LUNs and respective IDs of the virtual machines. In some implementations, the UFS host 710 may configure an association of queue resources to IDs of respective virtual machines. The queue resources may be associated with multiple queues of the UFS host 710 (e.g., multiple MCQs or multiple UFS command queues). For example, the UFS host 710 may associate queue resources for a queue 0 with an ID (e.g., ID 0) of the VM 0 720. The UFS host 710 may associate queue resources for a queue 1 with an ID (e.g., ID 1) of the VM 1 725.

As shown by reference number 745, the hypervisor 715 may transmit, and the VM 0 720 may receive, an indication of queue resources of a queue 0 (e.g., a queue of the UFS host 710). For example, the VM 0 720 may receive configuration information (e.g., via a device tree file) that indicates one or more register GPAs and/or one or more interrupt IDs associated with the queue 0. Similarly, as shown by reference number 750, the hypervisor 715 may transmit, and the VM 1 725 may receive, an indication of queue resources of a queue 1 (e.g., a different queue of the UFS host 710). For example, the VM 1 725 may receive configuration information (e.g., via a device tree file) that indicates one or more register GPAs and/or one or more interrupt IDs associated with the queue 1 of the UFS host 710.

As shown by reference number 755, the VM 0 720 may host a UFS driver with the configured queue resources (e.g., of queue 0). For example, the VM 0 720 may configure the UFS driver to perform I/O operations using the one or more registers indicated by the configuration information received from the hypervisor 715. Similarly, as shown by reference number 760, the VM 1 725 may host a UFS driver with the configured queue resources (e.g., of queue 1). For example, the VM 1 725 may configure the UFS driver to perform I/O operations using the one or more registers indicated by the configuration information received from the hypervisor 715.

As shown by reference number 765, the VM 0 720 may transmit, and the UFS device 705 may receive, a request on the queue 0 indicating the ID 0. For example, the VM 0 720 may transmit a command UPIU directly to the UFS device 705 (e.g., bypassing the hypervisor 715) using resources (e.g., a register and/or a GPA) of a queue that is configured for the VM 0 720 (e.g., by the hypervisor 715 as described in connection with reference number 745). For example, the VM 0 720 may access one or more register GPAs for a submission queue associated with the queue 0.

As shown by reference number 770, the VM 1 725 may transmit, and the UFS device 705 may receive, a request on the queue 1 indicating the ID 1. For example, the VM 1 725 may transmit a command UPIU directly to the UFS device 705 (e.g., bypassing the hypervisor 715) using resources (e.g., a register and/or a GPA) of a queue that is configured for the VM 1 725 (e.g., by the hypervisor 715 as described in connection with reference number 750). For example, the VM 1 725 may access one or more register GPAs for a submission queue associated with the queue 1.

As shown by reference number 775, the UFS host 710 may handle commands to the submission queues of the UFS host 710 (e.g., from the VM 0 720 and/or the VM 1 725). In some examples, the UFS host 710 may provide commands to the UFS device 705 indicating one or more LBAs of a given LUN to be accessed. For example, the UFS host 710 may handle commands from the VM 0 720 and/or the VM 1 725 indicating one or more LBAs of a given LUN to be accessed. The UFS host 710 may generate and transmit a command to the UFS device 705 indicating the one or more LBAs of the first LUN. The request from the VM 1 725 may indicate one or more LBAs of a second LUN to be accessed. The UFS host 710 may generate and transmit a command to the UFS device 705 indicating the one or more LBAs of the second LUN.

As shown by reference number 780, the UFS device 705 may perform actions for respective requests based on the association of IDs to LUNs (e.g., configured as described in connection with reference numbers 730 and 740). For example, for the request from the VM 0 720, the UFS device 705 may determine the ID indicated by the request (e.g., via an IID field in a header of the command UPIU). The UFS device 705 may determine whether the ID is bound to an LUN (e.g., the first LUN) indicated by the request or the command from the UFS host 710. If the ID is bound to (e.g., associated with) the LUN indicated by the request or the command from the UFS host 710, then the UFS device 705 may perform or complete a task indicated by the request (e.g., so long as the task is an I/O or DMA task). If the ID is not bound to (e.g., not associated with) the LUN indicated by the request or the command from the UFS host 710, then the UFS device 705 may refrain from performing or may deny the request.

Similarly, for the request from the VM 1 725, the UFS device 705 may determine the ID indicated by the request (e.g., via an IID field in a header of the command UPIU). The UFS device 705 may determine whether the ID (e.g., the ID 1) is bound to an LUN (e.g., the second LUN) indicated by the request or the command from the UFS host 710. If the ID is bound to (e.g., associated with) the LUN indicated by the request, then the UFS device 705 may perform or complete a task indicated by the request (e.g., so long as the task is an I/O or DMA task). If the ID is not bound to (e.g., not associated with) the LUN indicated by the request or the command from the UFS host 710, then the UFS device 705 may refrain from performing or may deny the request.

As shown by reference number 785, the UFS host 710 may generate interrupts for tasks performed by the UFS device 705. For example, the UFS device 705 may transmit, and the UFS host 710 may receive, an indication that a task associated with the request from the VM 0 720 is completed. The UFS host 710 may generate an interrupt for a completion queue that is associated with the VM 0 720 (e.g., a completion queue of the queue 0). Similarly, the UFS device 705 may transmit, and the UFS host 710 may receive, an indication that a task associated with the request from the VM 1 725 is completed. The UFS host 710 may generate an interrupt for a completion queue that is associated with the VM 1 725 (e.g., a completion queue of the queue 1).

As shown by reference number 790, the UFS host 710 may transmit, and the VM 0 720 may receive, an interrupt communication associated with the request from the VM 0 720. For example, the virtualization system may perform interrupt remapping to transmit the interrupt communication directly to the VM 0 720 (e.g., bypassing the hypervisor 715). Similarly, as shown by reference number 795, the UFS host 710 may transmit, and the VM 1 725 may receive, an interrupt communication associated with the request from the VM 1 725. For example, the virtualization system may perform interrupt remapping to transmit the interrupt communication directly to the VM 1 725 (e.g., bypassing the hypervisor 715).

As indicated above, FIG. 7 is provided as an example. Other examples may differ from what is described with regard to FIG. 7.

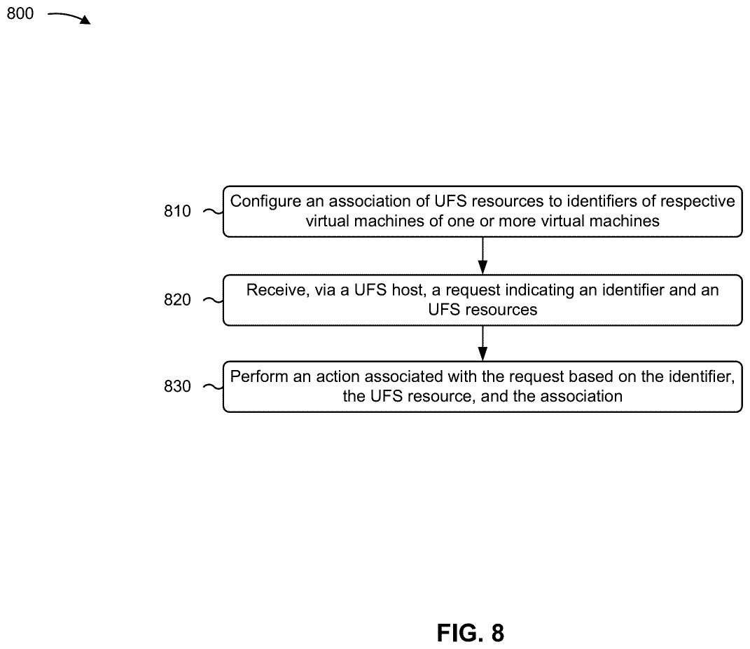

FIG. 8 is a flowchart of an example method 800 associated with flash storage device passthrough in a virtualization system. In some implementations, a memory system (e.g., the memory system 110, a memory device 120, the UFS device 410, the UFS device 705, the UFS host 405, and/or the UFS host 710) may perform or may be configured to perform the method 800. In some implementations, another device or a group of devices separate from or including the memory system (e.g., the hypervisor 415, the hypervisor 715, and/or one or more virtual machines) may perform or may be configured to perform the method 800. Additionally, or alternatively, one or more components of the memory system (e.g., one or more controllers) may perform or may be configured to perform the method 800. Thus, means for performing the method 800 may include the memory system and/or one or more components of the memory system. Additionally, or alternatively, a non-transitory computer-readable medium may store one or more instructions that, when executed by the memory system, cause the memory system to perform the method 800.

As shown in FIG. 8, the method 800 may include configuring an association of UFS resources to identifiers of respective virtual machines of one or more virtual machines (block 810). As further shown in FIG. 8, the method 800 may include receiving, via a UFS host, a request indicating an identifier and one or more UFS resources (block 820). As further shown in FIG. 8, the method 800 may include performing an action associated with the request based on the identifier, the one or more UFS resources, and the association (block 830). In some implementations, the UFS resources may be queue resources of multiple queues of a UFS host (e.g., a VM may be configured with resources of one or more queues of the UFS host). Additionally, or alternatively, the UFS resources may be LUNs of a UFS device (e.g., the UFS device may map an identifier of a virtual machine to one or more LUNs). The UFS device may perform the action associated with the request. For example, a UFS host may receive the request from a virtual machine via a queue of multiple queues associated with the UFS host. The UFS host may pass information (e.g., the ID and one or more LBAs of an LUN) associated with the request to the UFS device. The UFS device may determine, based on a mapping of IDs to LUNs stored by the UFS device, whether to perform the request based on the identifier indicated by the request and the mapping.

The method 800 may include additional aspects, such as any single aspect or any combination of aspects described below and/or described in connection with one or more other methods or operations described elsewhere herein.

In a first aspect, configuring the association of the UFS resources to the identifiers includes configuring the association of the UFS resources such that no two identifiers, of the identifiers, are associated with a same dedicated UFS resource.

In a second aspect, alone or in combination with the first aspect, configuring the association of the UFS resources to the identifiers includes configuring multiple identifiers, of the identifiers, to be associated with shared UFS resources.

In a third aspect, alone or in combination with one or more of the first and second aspects, the request is associated with a management command for the UFS device, and performing the action includes determining that the identifier indicates that the request is from a virtual machine of the one or more virtual machines, and refraining from completing the request based on the request being from the virtual machine.

In a fourth aspect, alone or in combination with one or more of the first through third aspects, the request is associated with a management command for the UFS device, and performing the action includes determining that the identifier indicates that the request is from a hypervisor associated with the one or more virtual machines, and performing the action to complete the request based on the request being from the hypervisor.

In a fifth aspect, alone or in combination with one or more of the first through fourth aspects, the one or more virtual machines host respective drivers of the UFS device, and a hypervisor hosts a UFS management driver of the UFS device.

In a sixth aspect, alone or in combination with one or more of the first through fifth aspects, receiving the request includes receiving a UTP command that includes the identifier in an initiator identifier field of the UTP command.

In a seventh aspect, alone or in combination with one or more of the first through sixth aspects, configuring the association of the UFS resources to the identifiers includes binding different LUNs to each of the identifiers.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

In some implementations, a system includes memory; and one or more controllers configured to: configure, for a UFS device of the system, an association of UFS resources to identifiers of respective virtual machines of one or more virtual machines; provide, via a hypervisor and for each virtual machine of the one or more virtual machines, one or more queue resources, of queue resources of a UFS host of the system, that are associated with that virtual machine based on the association, wherein each virtual machine is associated with one or more queues of multiple queues of the UFS host; receive, from a virtual machine of the one or more virtual machines and via the UFS host, a request to perform an operation associated with the memory, wherein the request indicates an identifier and is received via a queue of the multiple queues; and perform, by the UFS device, an action associated with the request based on the identifier, a UFS resource associated with the request, and the association.

In some implementations, a method includes configuring, by UFS device, an association of LUNs to identifiers of respective virtual machines of one or more virtual machines; receiving, by the UFS device and from a UFS host, a request indicating an identifier and a LUN, wherein the request is associated with a queue of multiple queues associated with the UFS host; and performing, by the UFS device, an action associated with the request based on the identifier, the LUN, and the association.

In some implementations, an apparatus includes means for receiving, via a hypervisor, an indication to bind different LUNs to one or more identifiers; means for configuring an association between the different LUNs and respective identifiers of the one or more identifiers; means for receiving, via a command queue of multiple command queues of a UFS host, a request indicating an identifier, of the one or more identifiers, and a LUN; and means for performing an action associated with the request based on whether the association indicates that the one or more LUNs are associated with the identifier.

In some implementations, a memory system includes one or more components configured to: receive a command indicating a set of LUNs to be associated with one or more identifiers, wherein the set of LUNs and the one or more identifiers have non-overlapping associations; configure, for a UFS device of the memory system, an association of the set of LUNs to identifiers of respective virtual machines of one or more virtual machines; configure, via a hypervisor and for each virtual machine of the one or more virtual machines, one or more queue resources for respective queues of a UFS host that are associated with that virtual machine, wherein the UFS host is associated with multiple queues; receive, via a queue of the multiple queues, a request to perform an operation associated with a LUN of the set of LUNs, wherein the request indicates an identifier; and perform, via the UFS device, an action associated with the request based on whether the association indicates that the identifier is associated with the LUN.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
memory; and
one or more controllers configured to:
configure, for a universal flash storage (UFS) device of the system, an association of UFS resources to identifiers of respective virtual machines of one or more virtual machines,
provide, via a hypervisor and for each virtual machine of the one or more virtual machines, one or more queue resources, of queue resources of a UFS host of the system, that are associated with that virtual machine based on the association,
wherein each virtual machine is associated with one or more queues of multiple queues of the UFS host;
receive, from a virtual machine of the one or more virtual machines and via the UFS host, a request to perform an operation associated with the memory,
wherein the request indicates an identifier and is received via a queue of the multiple queues; and
perform, by the UFS device, an action associated with the request based on the identifier, a UFS resource associated with the request, and the association.

2. The system of claim 1, wherein the UFS resources include logical unit numbers (LUNs) of the UFS device, and wherein the one or more controllers, to configure the association, are configured to:
configure a first one or more LUNs to be associated with a first identifier of a first virtual machine of the one or more virtual machines; and
configure a second one or more LUNs to be associated with a second identifier of a second virtual machine of the one or more virtual machines,
wherein the first one or more LUNs and the second one or more LUNs are mutually exclusive.

3. The system of claim 1, wherein each virtual machine of the one or more virtual machines hosts a UFS driver and one or more queues, of the multiple queues, that are associated with that virtual machine.

4. The system of claim 1, where the one or more controllers, to provide the one or more queue resources, are configured to:
provide, via configuration information for hardware components of the system, an indication of the one or more queue resources.

5. The system of claim 4, wherein the configuration information is included in a device tree file.

6. The system of claim 1, wherein the one or more controllers, to perform the action, are configured to:
determine, via the UFS device, whether the association indicates that the identifier is associated with the UFS resource; and
perform the action to:
complete the request if the association indicates that the identifier is associated with the UFS resource, or
deny the request if the association indicates that the identifier is not associated with the UFS resource.

7. The system of claim 1, wherein the identifiers are initiator identifiers included in a UFS protocol information unit (UPIU).

8. The system of claim 1, wherein the queue resources include at least one of:
one or more queue registers of the UFS host, or
one or more interrupt identifiers.

9. The system of claim 1, wherein the UFS resources include logical unit numbers (LUNs) of the UFS device.

10. A method, comprising:
configuring, by a universal flash storage (UFS) device, an association of logical unit numbers (LUNs) to identifiers of respective virtual machines of one or more virtual machines;
receiving, by the UFS device and from a UFS host, a request indicating an identifier and a LUN,
wherein the request is associated with a queue of multiple queues associated with the UFS host; and
performing, by the UFS device, an action associated with the request based on the identifier, the LUN, and the association.

11. The method of claim 10, wherein configuring the association of the LUNs to the identifiers comprises:
configuring the association of the LUNs such that no two identifiers, of the identifiers, are associated with a same dedicated LUN.

12. The method of claim 10, wherein configuring the association of the LUNs to the identifiers comprises:
configuring multiple identifiers, of the identifiers, to be associated with one or more shared LUNs.

13. The method of claim 10, wherein the request is associated with a management command for the UFS device, and wherein performing the action comprises:
determining that the identifier indicates that the request is from a virtual machine of the one or more virtual machines; and
refraining from completing the request based on the request being from the virtual machine.

14. The method of claim 10, wherein the request is associated with a management command for the UFS device, and wherein performing the action comprises:
determining that the identifier indicates that the request is from a hypervisor associated with the one or more virtual machines; and
performing the action to complete the request based on the request being from the hypervisor.

15. The method of claim 10, wherein the one or more virtual machines host respective drivers of the UFS host and a hypervisor hosts a UFS management driver of the UFS host.

16. The method of claim 10, wherein the request includes a UFS transport protocol (UTP) command that includes the identifier in an initiator identifier field of the UTP command.

17. A memory system, comprising:
one or more components configured to:
receive a command indicating a set of logical unit numbers (LUNs) to be associated with one or more identifiers,
wherein the set of LUNs and the one or more identifiers have non-overlapping associations;
configure, for a universal flash storage (UFS) device of the memory system, an association of the set of LUNs to identifiers of respective virtual machines of one or more virtual machines;
configure, via a hypervisor and for each virtual machine of the one or more virtual machines, one or more queue resources for respective queues of a UFS host that are associated with that virtual machine,
wherein the UFS host is associated with multiple queues;
receive, via a queue of the multiple queues, a request to perform an operation associated with a LUN of the set of LUNs,
wherein the request indicates an identifier; and
perform, via the UFS device, an action associated with the request based on whether the association indicates that the identifier is associated with the LUN.

18. The memory system of claim 17, wherein the one or more components, to configure the one or more queue resources, are configured to:
provide, by the hypervisor and via configuration information for that virtual machine, an indication of at least one of:
one or more registers, or
one or more interrupt identifiers.

19. The memory system of claim 17, wherein the one or more components, to configure the association, is configured to:
configure a first one or more LUNs to be associated with a first identifier of a first virtual machine of the one or more virtual machines; and
configure a second one or more LUNs to be associated with a second identifier of a second virtual machine of the one or more virtual machines,
wherein the first one or more LUNs and the second one or more LUNs are mutually exclusive.

20. The memory system of claim 17, wherein the one or more components, to perform the action, are configured to:
determine, via the UFS device, whether the association indicates that the identifier is associated with the LUN; and
perform the action to:
complete the request if the association indicates that the identifier is associated with the LUN, or
deny the request if the association indicates that the identifier is not associated with the LUN.
